(19) United States
(12) Patent Application Publication
(10) Pub. No.: US 2006/0034542 A1
(43) Pub. Date: Feb. 16, 2006

(54) Image generation method, image generation apparatus, and image generation program

(75) Inventor: Tatsuya Aoyama, Kanagawa-Ken (JP)

Correspondence Address: BIRCH STEWART KOLASCH & BIRCH, PO BOX 747, FALLS CHURCH, VA, 22040-0747, US

(73) Assignee: Fuji Photo Film Co., Ltd., Minamiashigara-shi (JP)

(21) Appl. No.: 11/203,239

(22) Filed: Aug. 15, 2005

(30) Foreign Application Priority Data
Aug. 16, 2004 (JP) 236516/2004
Jul. 20, 2005 (JP) 209855/2005

(51) Int. Cl. G06K 9/36; G06K 9/00

(52) U.S. Cl. 382/276; 382/115

(57) ABSTRACT

A reverse-aging image representing a skin part of a person in reverse aging is generated from an image of the skin part of the person at a predetermined age. Wrinkle component extraction means of an image generation unit extracts wrinkle components in frequency bands of a face image of the person obtained at the time of authentication of the person. Reverse-aging image generation means obtains the reverse-aging image by subtraction from the face image an adjustment component obtained by multiplication of a sum of the wrinkle components by an adjustment coefficient determined by pixel values of the face image, a reverse-aging period from the current age to the age at the time of registration, an age group in the reverse-aging period, and face parts.

### BACKGROUND OF THE INVENTION

1. Field of the Invention

The present invention relates to an image generation method and an image generation apparatus for generating a skin-part image such as the face of a person before or after aging. The present invention also relates to a program that causes a computer to execute the image generation method.

2. Description of the Related Art

Wrinkles and spots (hereinafter referred to as wrinkle/spot components) increase (both in amount and in intensity) in the skin of a person at portions such as the face, neck, and hands, as the person ages. Various kinds of processing using a relationship between the wrinkle/spot components and age have been proposed, and Japanese Unexamined Patent Publication No. 2002-304619 proposes a system for simulating an effect of wrinkles on an impression (how old and attractive a person looks). In this system, face-part images with wrinkles and without wrinkles are generated for a part around eyes and foreheads, a part around mouths, nasolabial lines, cheeks, and the like, and a face image is generated by using a combination of the face-part images with and without wrinkles, such as an image of eyes with wrinkles, an image of foreheads without wrinkles, an image of mouths without wrinkles, an image of nasolabial lines with wrinkles, and images of cheeks with wrinkles. Based on the face image generated in this manner, the effects of aging are simulated.

Furthermore, Japanese Unexamined Patent Publication No. 6(1994)-333005 proposes a system for generating a face image according to age by combining face parts having characteristic quantities such as wrinkles, spots, acne, and skin roughness generated in advance according to age.

Meanwhile, following improvement in image recognition technologies, a system has also been proposed for carrying out authentication by recognizing a human face and by comparing the face with a registered face image (see “Face Recognition System Using Face Images” by Yamaguchi et al., The Technical Report of The Proceeding of The Institute of Electronics, Information, and Communication Engineers PRMU97-50, June 1997). Such an authentication system carries out authentication by pattern matching with a face image of a target person and a face image stored in a database.

Moreover, skin enhancement processing is conventionally carried out on photograph images including a face, by suppressing and removing wrinkles and spots from the photograph. For example, a low-pass filter generally used for noise reduction is applied to remove wrinkle and spot components. However, although a low-pass filter can suppress wrinkles, spots, and noise in an image, the low-pass filter also blurs edges in the image. Therefore, the entire image becomes blurry, which is problematic.

In addition, an ε-filter (an ε-separating nonlinear digital filter) is applied to removal of wrinkles and spots (see “Color Face Image Processing by Vector ε-filter—Removal of Wrinkles” by Arakawa et al., The Proceeding of the IEICE General Conference D-11-43 PP. 143-, March 1998). This method pays attention to the fact that wrinkles and spots mainly appear as signals of small amplitude in high-frequency components in an image, and uses the ε-filter that has been originally developed for separating and suppressing high-frequency noise components of small amplitude. The ε-filter smoothes only a small-amplitude change in an image signal, and the image processed by the ε-filter thus preserves edges that have sharp changes. Therefore, the sharpness of the entire image is rarely affected.

An ε-filter basically subtracts a value obtained by application of a non-linear function from a change in amplitude from an original image signal. The non-linear function outputs 0 if the amplitude is larger than a predetermined threshold value. The output of the non-linear function corresponds to the wrinkle/spot components in the image. In other words, when the ε-filter is applied, the output of the non-linear function is 0 in a part of the image wherein the amplitude is larger than the predetermined threshold value. Therefore, in the image after the processing, the image signal in the part is maintained while a part of the image wherein the amplitude is not larger than the threshold value is represented by a value obtained as subtraction of the output of the non-linear function (whose absolute value is larger than 0) from the original image signal. In this manner, the wrinkles and spots, which are not noise but represent small-amplitude changes in lightness, can be smoothed and become inconspicuous while edges having large amplitude can be maintained.

However, skin conditions such as degrees of wrinkle/spot components in human faces change with age. Therefore, in the above-described system by Yamaguchi et al. for carrying out authentication through pattern matching between a current face image of a target person and a pre-registered face image of the person, accuracy of authentication deteriorates in the case where authentication is carried out years after registration of the face image. For this reason, updates of face images may be carried out at appropriate times. However, if the number of people to be registered is large, an operation for the update becomes a heavy burden. Especially, in the case where the system is used for finding a criminal, the update operation is often impossible to carry out and is not realistic.

Therefore, instead of updating a face image, authentication may be carried out by using a face image generated according to current age from face-part images, as has been described by Arakawa et al., for example. In this case, registration of the face-part images according to current age is not realistic due to the same reason for the case of update of face image registration. Therefore, face-part images of a large number of people (sample people) in different age groups may be prepared so that a face image of a target person can be generated by selection of the face-part images having close outline and age to the target person. However, although the outline is similar, the selected face-part images are not face-part images of the target person. Consequently, the face image generated from the face-part images cannot achieve high authentication accuracy. In addition, degrees of wrinkles and spots vary, among people of the same age. Therefore, the face image generated from the face-part images of the sample people may be significantly different from the target person, which further deteriorates authentication accuracy. For this reason, it is desired to generate a face image of a target person after aging from a registered face image.

Furthermore, not only in an authentication system but also in a simulation system described in Japanese Unexamined Patent Publication No. 2002-304619, simulation of a face-part image according to age of a target person is expected. The degrees of wrinkle/spot components vary according to age, and the simulation system described in Japanese Unexamined Patent Publication No. 2002-304619 using a combination of face parts with or without wrinkles cannot simulate the effect of wrinkles according to age, although the system can allow confirmation of an effect of wrinkles in a face part. Therefore, a system may be proposed for simulating a change in impression of a face with aging by combining face parts with wrinkles generated according to aging as well as face parts with and without wrinkles. In order to realize such a system, generation of face-part images according to age is necessary.

### SUMMARY OF THE INVENTION

The present invention has been conceived based on consideration of the above circumstances. An object of the present invention is therefore to provide an image generation method, an image generation apparatus, and a program for generating an image of a person at a different age from a predetermined age by using an image of the face of the person at the predetermined age or a part thereof.

An image generation method of the present invention is a method of generating an after-aging image representing an image of a skin part of a person after aging and/or a reverse-aging image representing an image of the skin part of the person in reverse aging by using an image of the skin part of the person at a predetermined age as a current-age image. The image generation method comprises the steps of:

extracting a component that enables representation of a state of skin and increases with aging as an age component, from the current-age image;

obtaining an adjustment component by adjusting the age component with a predetermined adjustment strength; and

adding the adjustment component to the current-age image in the case of generating the after-aging image and subtracting the adjustment component from the current-age image in the case of generating the reverse-aging image.

The phrase “after aging” refers to a state after a predetermined time has passed from the predetermined age. On the contrary, the phrase “reverse aging” refers to a state before the predetermined age, that is, a state of aging before the predetermined age.

Increasing with aging refers to an increase in an amount and/or intensity of the component.

As the age component may be listed a wrinkle component and/or a spot component (hereinafter collectively referred to as wrinkle components).

A method of extracting the wrinkle components as the age component may comprise the steps of:

generating a plurality of band-limited images representing components in a plurality of frequency bands of the current-age image, based on the current-age image;

obtaining pixel values of a plurality of conversion images by carrying out non-linear conversion processing on each pixel value of each of the band-limited images whereby an absolute value of an output value becomes not larger than an absolute value of a corresponding input value and an absolute value of an output value becomes larger as an absolute values of a corresponding input value becomes larger if the absolute value of the input value is not larger than a predetermined threshold value while an absolute value of an output value becomes not larger than an absolute value of an output value corresponding to the predetermined threshold value if otherwise; and

obtaining pixel values of an age component image representing the age component by adding up the pixel values of corresponding pixels in the conversion images, for example.

Pixel values of an image representing the adjustment component can be obtained by multiplying the pixel values of the age component image by an adjustment coefficient representing the adjustment strength.

Although the adjustment coefficient may be the same for all the pixel values, it is preferable for the adjustment coefficient to be determined according to pixel values of the current-age image.

In the image generation method of the present invention, if the adjustment strength becomes larger as a degree of aging or reverse aging becomes larger, an image according to the degree of aging or reverse aging can be generated from the current-age image. The degree of aging or reverse aging refers to a length of a period of aging or reverse aging, such as in years.

A degree of change in the age component such as the wrinkle components in human skin varies, with the length in the aging or reverse aging period and an age group in the period. For example, if an increase in wrinkles in aging from 20 years old to 25 years old is represented by 1, the increase in wrinkles respectively becomes 1.15, 1.15, 1.2, and 1.1 from 25 to 30 years old, 30 to 35 years old, 35 to 40 years old, and 40 to 45 years old, although the lengths of the aging periods are maintained at 5 years. Depending on the age group in the aging period, the increase in the wrinkle components changes. Likewise, if a decrease in wrinkles is represented by 1 in the case where the age decreases from 25 to 20, the decrease in wrinkles respectively becomes 1.1, 1.2, 1.15, and 1.15 for the period from 45 to 40 years old, 40 to 35 years old, 35 to 30 years old, and 30 to 25 years old. Depending on the age group in the reverse aging period, the decrease in the wrinkle components changes. The image generation method of the present invention takes these facts into consideration. Therefore, the adjustment strength is preferably determined according to not only the length of the period of aging or reverse aging but also according to the age group in the period. In this manner, the after-aging image and the reverse-aging image can be obtained appropriately.

Furthermore, the degree of change in the age component such as the wrinkle components of human skin varies from body part to body part. For example, although the length and the age group in the aging period are the same, the wrinkle components generally increase more in entire faces than in hands, while the wrinkle components generally increase more in hands than in necks. In addition, the wrinkle components increase with aging in various degrees in different face parts such as outer eye corners, foreheads, and chins in the same length of aging period. The same phenomena are observed in the case of reverse aging. Therefore, the adjustment strength in the image generation method of the present invention is preferably determined according to the body part to which the skin part belongs.

An image generation apparatus of the present invention is an apparatus for generating an after-aging image representing an image of a skin part of a person after aging and/or a reverse-aging image representing an image of the skin part of the person in reverse aging by using an image of the skin part of the person at a predetermined age as a current-age image. The image generation apparatus comprises:

age component extraction means for extracting a component that enables representation of a state of skin and increases with aging as an age component, from the current-age image;

adjustment component acquisition means for obtaining an adjustment component by adjusting the age component with a predetermined adjustment strength; and

image generation means for generating the after-aging image by adding the adjustment component to the current-age image and for generating the reverse-aging image by subtracting the adjustment component from the current-age image.

The age component may be a wrinkle component and/or a spot component (hereinafter referred to as wrinkle components), and the age component extraction means that extracts the wrinkle components preferably:

generates a plurality of band-limited images representing components in a plurality of frequency bands of the current-age image, based on the current-age image;

obtains pixel values of a plurality of conversion images by carrying out non-linear conversion processing on each pixel value of each of the band-limited images whereby an absolute value of an output value becomes not larger than an absolute value of a corresponding input value and an absolute value of an output value becomes larger as an absolute value of a corresponding input value becomes larger if the absolute value of the input value is not larger than a predetermined threshold value while an absolute value of an output value becomes not larger than an absolute value of an output value corresponding to the predetermined threshold value if otherwise; and

obtains pixel values of an age component image representing the age component by adding up the pixel values of corresponding pixels in the conversion images.

In this case, the adjustment component acquisition means obtains pixel values of an image representing the adjustment component by multiplying the pixel values of the age component image by an adjustment coefficient representing the adjustment strength.

The adjustment coefficient is preferably determined for each pixel value of the current-age image.

It is preferable for the adjustment strength to become larger as a degree of aging or reverse aging becomes larger.

Furthermore, the adjustment strength is preferably determined according to an age group in an aging or reverse aging period.

It is more preferable for the adjustment strength to be determined according to the body part to which the skin part belongs, a degree of the age component, use or nonuse of makeup in the current-age image or the after-aging image or the reverse-aging image, or a color of the skin of the person.

A program of the present invention is a program for causing a computer to execute the image generation method.

In the image generation method, the image generation apparatus, and the program of the present invention, the age component such as the wrinkle components is extracted from the current-age image of the skin part, and the after-aging or reverse-aging image is obtained by adding or subtracting the adjustment component obtained by adjustment of the age component with the predetermined adjustment coefficient to or from the current-age image. Since the after-aging or reverse-aging image is generated from the current-age image of the person, an effect of difference among individuals in the age component is not observed.

Furthermore, by adjusting the age component according to the length of aging or reverse-aging period, the age group in the aging or reverse-aging period, and the body part, the after-aging or reverse-aging image can be obtained appropriately according to age.

### BRIEF DESCRIPTION OF THE DRAWINGS

FIG. 1 is a block diagram showing the configuration of an authentication apparatus of an embodiment of the present invention;

FIG. 2 is a block diagram showing the configuration of an authentication unit 100 in the authentication apparatus shown in FIG. 1;

FIG. 3 is a block diagram showing the configuration of an image generation unit 60 in the authentication unit 100 shown in FIG. 2;

FIG. 4 is a block diagram showing the configuration of blurry image generation means 10 in the image generation unit 60 shown in FIG. 3;

FIG. 5 shows an example of a one-dimensional filter F used by filtering means 12 in the blurry image generation means 10 shown in FIG. 4;

FIG. 6 shows processing carried out in the blurry image generation means 10;

FIG. 7 shows frequency characteristics of filtering images Bk generated by the filtering means 12;

FIG. 8 shows an example of a two-dimensional filter used by the filtering means 12;

FIG. 9 shows an example of a filter F1 used for interpolation of a filtering image B1 by interpolation means 14 in the blurry image generation means 10;

FIG. 10 shows an example of a filter F2 used for interpolation of a filtering image B2 by interpolation means 14;

FIG. 11 shows frequency characteristics of blurry images Sk generated by the blurry image generation means 10;

FIG. 12 shows frequency characteristics of band-limited images Tk generated by band-limited image generation means 20 in the image generation unit 60;

FIG. 13 shows an example of a function f used by wrinkle component extraction means 30 in the image generation unit 60;

FIG. 14 is a block diagram showing the configuration of reverse-aging image generation means 40 in the image generation unit 60;

FIG. 15 shows the content of a first database 120;

FIG. 16 shows the content of a second database 140; and

FIG. 17 is a flow chart showing a procedure carried out by the authentication apparatus.

### DESCRIPTION OF THE PREFERRED EMBODIMENT

Hereinafter, an embodiment of the present invention will be described with reference to the accompanying drawings.

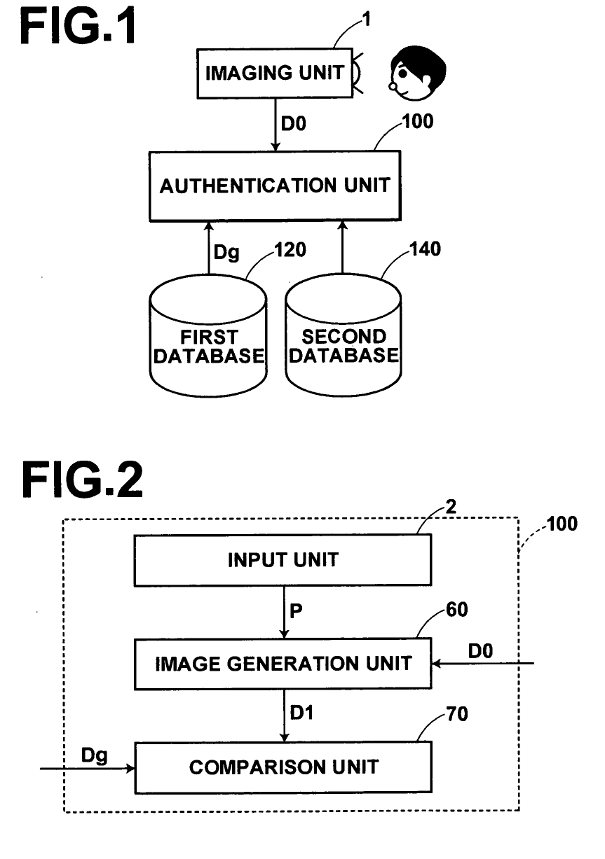

FIG. 1 is a block diagram showing the configuration of an authentication apparatus as an embodiment of the present invention. The authentication apparatus in this embodiment is realized by causing a computer (such as a personal computer) to execute an authentication program read into an auxiliary storage device. The authentication program may alternatively be stored in an information recording medium such as a CD-ROM or distributed via a network such as the Internet, and installed in the computer.

Since image data represents an image, “an image” and “image data” are used without distinction therebetween in the following description.

As shown in FIG. 1, the authentication apparatus in this embodiment comprises an imaging unit 1, an authentication unit 100, a first database 120, and a second database 140. The imaging unit 1 obtains a face image D0 by photography of a person to be authenticated. The first database 120 stores a registered face image Dg of the person in relation to the age of the person at the time of registration. The second database 140 stores various kinds of parameters to be provided to the authentication unit 100. The authentication unit 100 carries out authentication by using the face image D0, the registered face image Dg stored in the first database 120, and the parameters stored in the second database 140.

FIG. 2 is a block diagram showing the configuration of the authentication unit 100 in the authentication apparatus in the embodiment shown in FIG. 1. As shown in FIG. 2, the authentication unit 100 comprises an input unit 2, an image generation unit 60, and a comparison unit 70. The input unit 2 is used when the person to be authenticated inputs information that enables identification of the person (such as a password P of the person). The image generation unit 60 generates a face image D1 representing a face image of the person at the age of registration of the face image Dg (hereinafter referred to as a reverse-aging image D1) by using the face image D0 of the person at the current age obtained by the imaging unit 1. The comparison unit 70 compares the registered face image Dg stored in the first database 120 with the reverse-aging image D1 generated by the image generation unit 60.

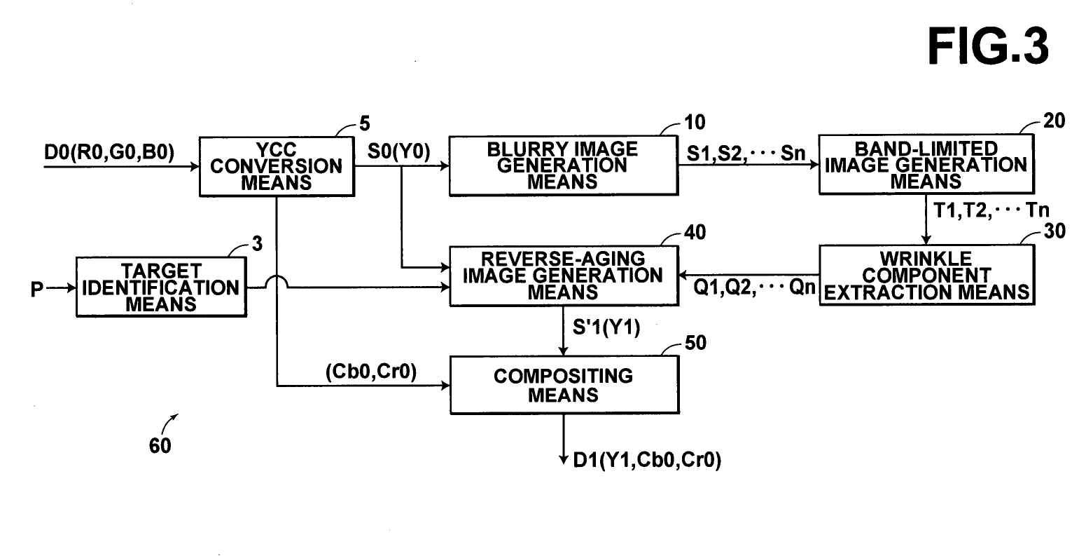

FIG. 3 is a block diagram showing the configuration of the image generation unit 60 in the authentication unit 100 shown in FIG. 2. As shown in FIG. 3, the image generation unit 60 comprises target identification means 3, YCC conversion unit 5, blurry image generation means 10, band-limited image generation means 20, wrinkle component extraction means 30 for extracting wrinkle/spot components (hereinafter collectively referred to as wrinkle components), reverse-aging image generation means 40, and compositing means 50.

The blurry image generation means 10 generates a plurality of blurry images S1 to Sn (where n is a natural number larger than 1) having different frequency response characteristics from an original image S0, and the band-limited image generation means 20 generates a plurality of band-limited images T1 to Tn by using the original image S0 and the blurry images S1 to Sn. The wrinkle component extraction means 30 extracts wrinkle components Q1 to Qn in frequency bands corresponding to the band-limited images by carrying out non-linear conversion processing on the band-limited images T1 to Tn. The reverse-aging image generation means 40 generates a reverse-aging image S′1 of the original image S0 by using the wrinkle components Q1 to Qn and the original image S0. Since the-above described means carry out processing in a luminance space, the YCC conversion means 5 carries out YCC conversion on the face image D0 (R0, G0, B0) obtained by the imaging unit 1, for obtaining a luminance component Y0 (comprising the original image S0) and color difference components Cb0 and Cr0. The compositing means 50 obtains the reverse-aging image D1(Y1, Cb0, Cr0) by compositing images represented by pixel values Y1 of the reverse-aging image S′1 obtained by the reverse-aging image generation means 40 and the color difference components Cb0 and Cr0 obtained by the YCC conversion means 5. Hereinafter, the image generation unit 60 will be described in detail.

The YCC conversion means 5 converts R, G, and B values of the face image D0 into a luminance component Y and color difference components Cb and Cr according to Equation (1) below:
Y=0.2990×R+0.5870×G+0.1140×B Cb=−0.1687×R−0.3313×G−0.5000×B+128 Cr=0.5000×R−0.4187×G−0.0813×B+128 (1)

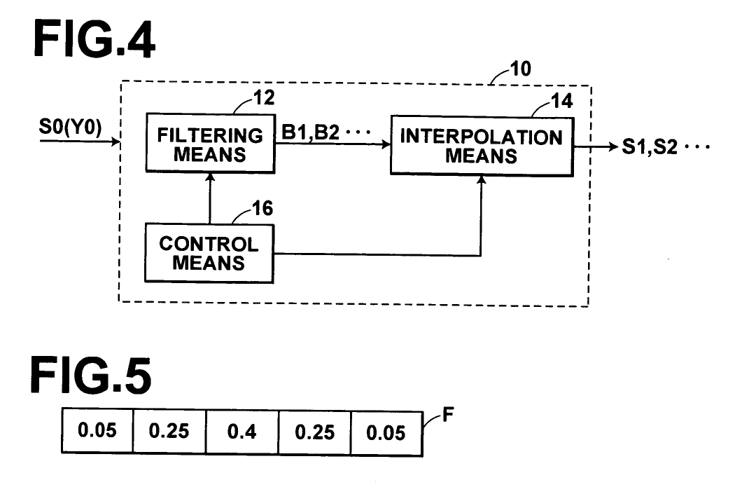

The blurry image generation means 10 generates the blurry images by using the luminance component Y0 obtained by the YCC conversion means 5. FIG. 4 is a block diagram showing the configuration of the blurry image generation means 10. As shown in FIG. 4, the blurry image generation means 10 comprises filtering means 12 for obtaining filtering images B1 to Bn having been subjected to thinning processing after filtering processing, interpolation means 14 for carrying out interpolation processing on the filtering images, and control means 16 for controlling the filtering means 12 and the interpolation means 14. The filtering means 12 carries out the filtering processing by using a low-pass filter. The low-pass filter may be a filter F of 1×5 elements having a one-dimensional Gaussian distribution, as shown in FIG. 5, for example. The filter F can be obtained by letting σ=1 in Equation (2) below:

$${f}_{( t )} = {ⅇ}^{- \frac{{t}^{2}}{2 {σ}^{2}}} \qquad ( 2 )$$

The filtering means 12 filters the entire image to be processed, through the filtering processing on x and y directions of the image by using the filter F and ½ thinning processing thereon.

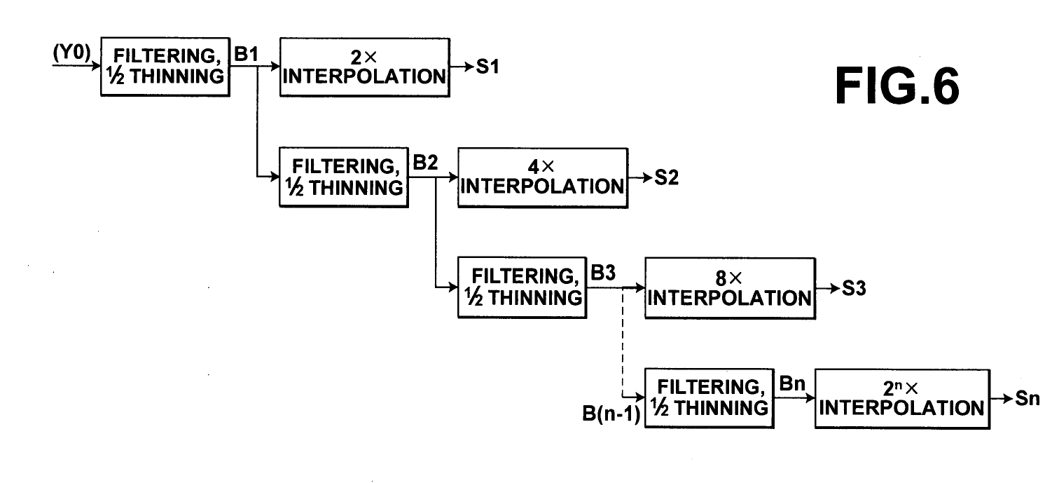

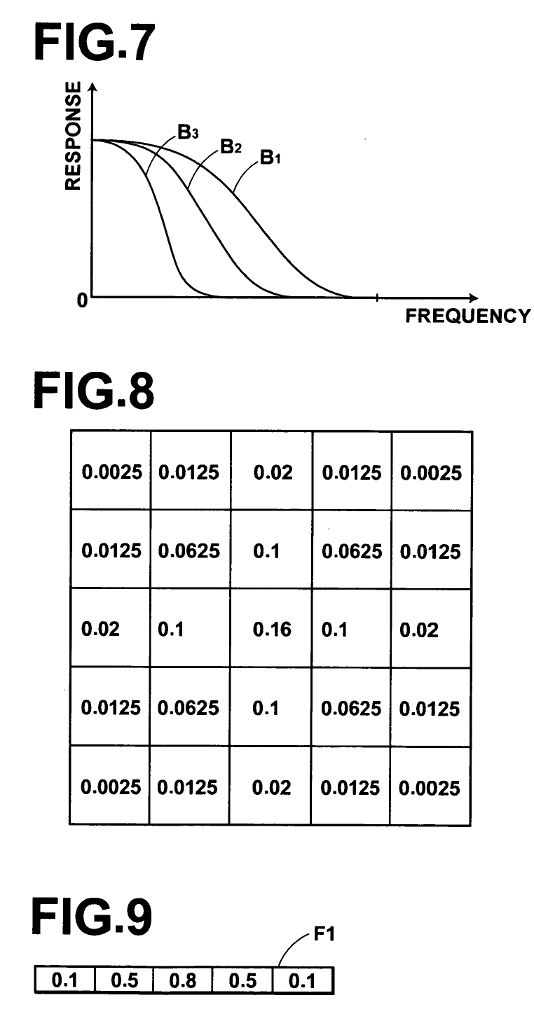

FIG. 6 shows a detailed procedure carried out by the filtering means 12 and the interpolation means 14 under the control of the control means 16 in the blurry image generation means 10. As shown in FIG. 6, the filtering means 12 carries out the filtering processing on every other pixel in the original image S0 (Y0) by using the filter F shown in FIG. 5, and thins the pixels not having been subjected to the filtering processing. In this manner, the filtering image B1 (Y1) is obtained. The filtering image B has ¼ of a size of the original image S0 (that is, ½ for the x direction and for the y direction). The filtering means 12 carries out the filtering processing and the thinning processing on the filtering image B1 (Y1) on every other pixel therein, and obtains the filtering image B2 (Y2). The filtering means 12 repeats the filtering processing with the filter F and the ½ thinning processing for obtaining the n filtering images (hereinafter referred to as the filtering images Bk where k=1˜n) . The size of each of the filtering images Bk is ½^{k} of the original image S0. FIG. 7 shows frequency characteristics of the filtering images Bk obtained by the filtering means 12 in the case of n=3. As shown in FIG. 7, a response of each of the filtering images Bk lacks more high-frequency components as k becomes larger.

In this embodiment, the filtering means 12 carries out the filtering processing by using the filter F shown in FIG. 5 in x and y directions of the image. However, filtering processing may be carried out at once on the original image S0 and the filtering images Bk, by using a 5×5 two-dimensional filter shown in FIG. 8.

The interpolation means 14 carries out the interpolation processing on the filtering images Bk obtained by the filtering means 12, and causes the size of each of the filtering images Bk to become the same as the original image S0. A method of interpolation may be a method using a B-spline or the like. In this embodiment, since the filtering means 12 uses the filter F as the low-pass filter based on a Gaussian signal, the interpolation means 14 uses a Gaussian signal as an interpolation coefficient for carrying out an interpolation operation. The interpolation coefficient is obtained by approximation of Equation (3) below with σ=2^{k-1}:

$${I}_{( t )} = 2 \times σ \times {ⅇ}^{- \frac{{t}^{2}}{2 {σ}^{2}}} \qquad ( 3 )$$

When the filtering image B1 is interpolated, k=1. Therefore, σ=1. A filter for carrying out interpolation for the case of σ=1 in Equation (3) above is a 1×5 one-dimensional filter F1 shown in FIG. 9. The interpolation means 14 enlarges the filtering image B1 to the size of the original image S0 by inserting a pixel whose value is 0 into every other pixel therein, and carries out the filtering processing using the filter F1 shown in FIG. 9 on the enlarged image. In this manner, the blurry image S1 is obtained. The blurry image S has the same number of pixels (that is, the same size) as the original image S0.

The filter F1 shown in FIG. 9 has the 1×5 elements. Before applying the filter F1 to the filtering image B1, the filtering image B1 has been subjected to the insertion of the pixel whose value is 0 into every other pixel. Therefore, the interpolation processing by the interpolation means 14 is actually equivalent to filtering processing by a 1×2 filter (0.5, 0.5) and a 1×3 filter (0.1, 0.8, 0.1).

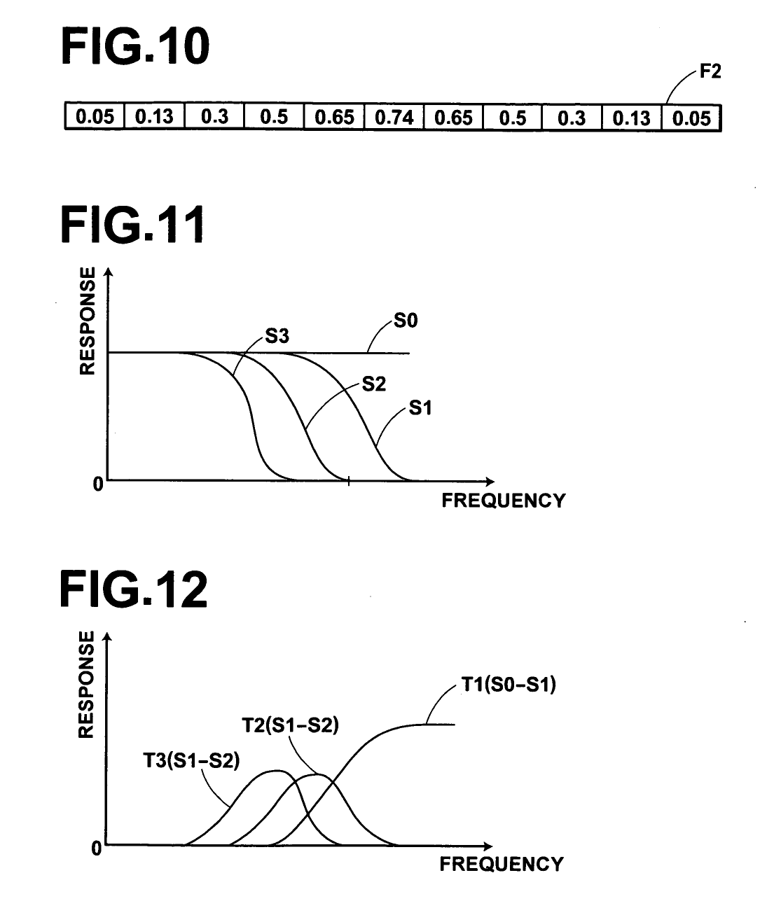

When the interpolation means 14 carries out the interpolation processing on the filtering image B2, k=2. Therefore, σ=2. A filter corresponding to σ=2 in Equation (3) above is a 1×11 one-dimensional filter F2 shown in FIG. 10. The interpolation means 14 inserts 3 pixels whose values are 0 into every other pixel of the filtering image B2, for enlarging the filtering image B2 to the same size as the original image S0. The interpolation means 14 then carries out the filtering processing using the filter F2 shown in FIG. 10 on the enlarged image, in order to obtain the blurry image B2. The blurry image B2 has the same number of pixels (the same size) as the original image S0.

The filter F2 shown in FIG. 10 is the 1×11 filter, and the 3 pixels whose values are 0 have been inserted into every other pixel in the filtering image B2 before application of the filter F2 to the filtering image B2. Therefore, the interpolation processing by the interpolation means 14 is actually equivalent to filtering processing using one 1×2 filter (0.5, 0.5) and three 1×3 filters (0.3, 0.65, 0.05), (0.3, 0.74, 0.13), and (0.05, 0.65, 0.3).

The interpolation means 14 inserts (2ₖ−1) pixels whose values are 0 into every other pixel of each of the filtering images Bk to enlarge the filtering images Bk to the same size as the original image S0, and obtains the blurry images Sk by filtering processing using a filter whose length is (3×2^{k}−1) generated according to Equation (3) on the interpolated filtering images Bk.

FIG. 11 shows frequency characteristics of the blurry images Sk obtained by the blurry image generation means 10 for the case of n=3. As shown in FIG. 11, high-frequency components of the original image S0 are eliminated more in the blurry images Sk as k becomes larger.

The band-limited image generation means 20 generates the band-limited images T1 to Tn representing components of frequency bands in the original image S0 according to Equation (4) below, by using the blurry images S1 to Sn generated by the blurry image generation means 10:
Tm=S(m−1)−Sm (4)
where m is an integer ranging from 1 to n.

FIG. 12 shows frequency characteristics of the band-limited images Tm obtained by the band-limited image generation means 20 for the case of n=3. As shown in FIG. 12, the band-limited images Tm represent components of lower frequency ranges of the original image S0 as m becomes larger.

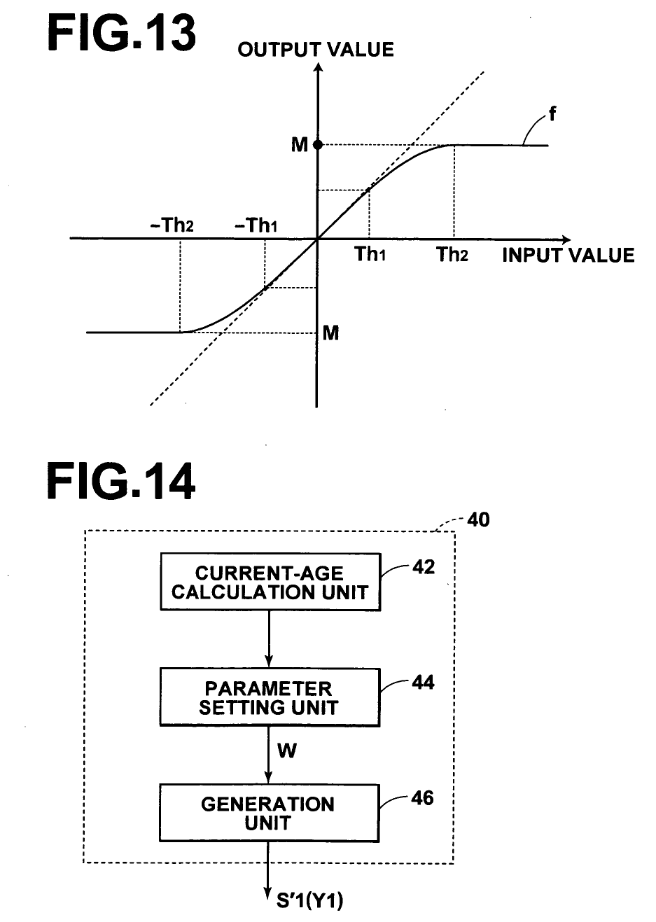

The wrinkle component extraction means 30 carries out the non-linear conversion processing on the band-limited images Tm (m=1˜n) obtained by the band-limited image generation means 20, and extracts the wrinkle components Q1 to Qn representing components of wrinkles, spots and noise in the respective frequency bands corresponding to the band-limited images Tm. The non-linear conversion processing is processing for causing an output value to become equal to or smaller than an input value. For an input value not larger than a predetermined threshold value, the non-linear conversion processing causes an output value thereof to become larger as the input value becomes larger. For an input value larger than the predetermined threshold value, the non-linear conversion processing causes an output value thereof to become equal to or smaller than an output value corresponding to the predetermined threshold value. In this embodiment, the non-linear conversion processing is carried out according to a function f shown in FIG. 13. The broken line in FIG. 13 shows a function whose input value is equal to an output value, that is, a function whose slope is 1. The slope of the function f used in the non-linear conversion processing by the wrinkle component extraction means 30 in this embodiment is 1 in the case where an absolute value of an input value is smaller than a first threshold value Th1, but the slope is smaller than 1 in the case where an absolute value of an input value is equal to or larger than the first threshold value Th1 but not larger than a second threshold value Th2. In the case where an absolute value of an input value is larger then the second threshold value Th2, an output value thereof becomes M whose absolute value is smaller than the absolute value of the input value. The function f may be the same for all the band-limited images or may be different for the respective band-limited images.

The wrinkle component extraction means 30 uses luminance values of each of the band-limited images as the input values, and carries out the non-linear conversion processing using the function f shown in FIG. 13 on the band-limited images. The wrinkle component extraction means 30 then extracts the wrinkle components Qm (m=1˜n) comprising the luminance values of the output value in each of the frequency bands corresponding to the band-limited images. The wrinkle component extraction means 30 outputs the wrinkle components to the reverse-aging image generation means 40.

Meanwhile, the target identification means 3 reads the registered face image Dg stored in relation to the password P in the first database 120 (which will be described later), based on the password P input via the input unit 2 of the authentication unit 100. In addition, the target identification means 3 reads the age of the person at the time of registration, date of registration, and gender of the person corresponding to the registered face image Dg from the first database 120. The target identification means 3 outputs the registered face image Dg to the comparison unit 70 of the authentication unit 100, and outputs information representing the age at the time of registration (hereinafter referred to as the registration-time age), the gender, and the date of registration of the person to the reverse-aging image generation means 40.

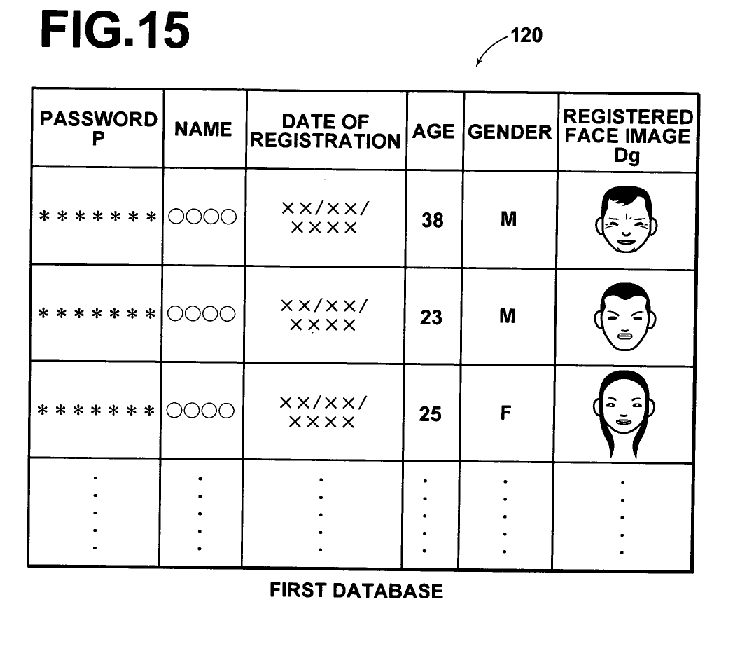

FIG. 15 shows the content of the first database 120. As shown in FIG. 15, the first database 120 stores the name, the password, the gender, the registered face image Dg, the registration-time age, the date of registration, regarding the person. The target identification means 3 reads the registered face image Dg and the information on the person, based on the password P input via the input unit 2.

The reverse-aging image generation means 40 generates the reverse-aging image S′1(Y1) of the original image S0, by using the original image S0 obtained by the YCC conversion means 5, the wrinkle components Q1 to Qn in the original image S0 obtained by the wrinkle component extraction means 30, and the various kinds of parameters stored in the second database 140. FIG. 14 shows the configuration of the reverse-aging image generation means 40. As shown in FIG. 14, the reverse-aging image generation means 40 comprises a current-age calculation unit 42, a parameter setting unit 44, and a generation unit 46.

The current-age calculation unit 42 calculates the current age of the person to be authenticated, based on the registration-time age output from the target identification means 3 and date of authentication, and outputs the current age to the parameter setting unit 44.

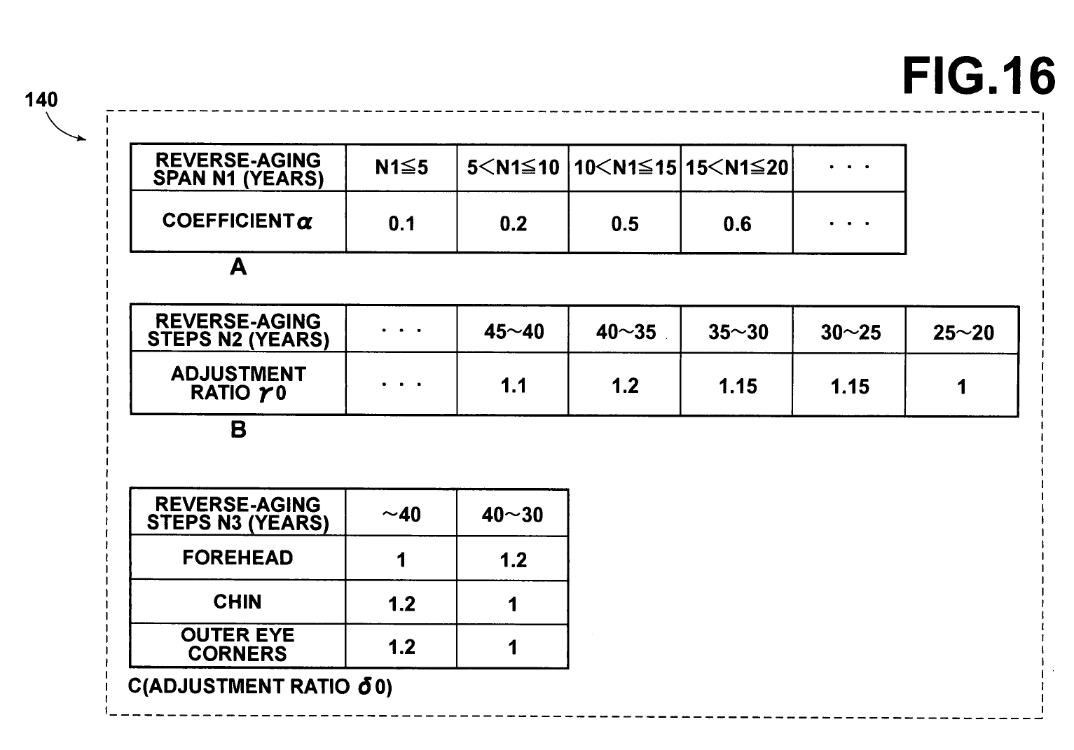

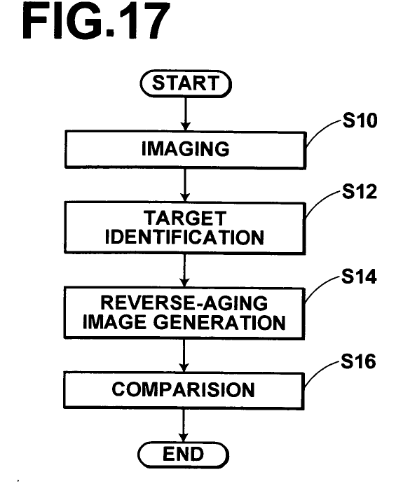

The parameter setting unit 44 sets parameters W for generating the reverse-aging image S′1(Y1) with use of the current age calculated by the current-age calculation unit 42, the registration-time age of the person, and the various kinds of parameters stored in the second database 140. Processing carried out by the parameter setting unit 44 will be described with reference to the database 140 shown in FIG. 16.

As shown in FIG. 16, the second database 140 comprises databases A, B, and C.

The database A stores a reverse-aging span N1 in years representing the difference between the current age and the registration-time age, and a coefficient a corresponding thereto. The coefficient a becomes larger as the reverse-aging span N1 becomes longer. In the example shown in FIG. 16, the coefficient α is 0.1, 0.2, 0.5, 0.6 and soon for the reverse-aging span N1 being shorter than 5 years, 5 to 10 years, 10 to 15 years, 15 to 20 years and so on. The parameter setting unit 44 calculates the reverse-aging span N1 from the current age calculated by the current-age calculation unit 42 and the registration-time age output from the target identification means 3, and reads the coefficient a corresponding to the reverse-aging span N1 from the database A.

The database B stores reverse-aging steps N2 comprising age groups in a period of reverse-aging and adjustment ratios γ0 corresponding thereto. As has been described above, a change in wrinkles (either increase or decrease in amount and intensity) becomes different, depending on the age groups in the reverse-aging period. Therefore, the second database 140 in this embodiment takes this fact into consideration, and divides the reverse-aging period into the reverse-aging steps N2 for which the adjustment ratios γ 0 have been determined respectively. In the example shown in FIG. 16, the database B stores the reverse-aging steps N2 comprising age groups of 45 to 40 years old, 40 to 35 years old, 35 to 30 years old, 30 to 25 years old, and 25 to 20 years old, and the corresponding adjustment ratios γ0. The parameter setting unit 44 reads the adjustment ratios γ0 of the corresponding reverse-aging steps N2 (hereinafter referred to as γ0(1), γ0(2), γ0(3) and so on), based on the current age and the registration-time age. More specifically, in the case where the current age of the person to be authenticated is 25 while the registration-time age of the person is 21, for example, the reverse-aging step N2 to which the reverse-aging period belongs is only the reverse-aging step N2 corresponding to the age group of 25 to 20 years old in the database B in FIG. 16. Therefore, only 1 is read from the database B as the adjustment ratio γ0(1) for the reverse-aging step N2. In the case where the current age of the person is 44 while the registration-time age of the person is 31, the reverse-aging period belongs to the reverse-aging steps N2 comprising the age groups of 45 to 40, 40 to 35, and 35 to 30 years old. Therefore, 1.1, 1.2, and 1.15 are read as the adjustment ratios γ0(1), γ0(2), and γ0(3) for the respective reverse-aging steps N2.

The parameter setting unit 44 calculates an actual adjustment ratio γ by using the adjustment ratios γ0 that have been read, according to Equation (5) below:
γ=γ0(1)×γ0(2)× . . . γ0(k) (5)

where k is the number of the adjustment ratios γ0 having been read.

The database C stores reverse-aging steps N3 and corresponding adjustment ratios δ0 for each of face parts. How the wrinkle components increase with aging is different, depending on face parts such as outer eye corners, forehead, and chin. For example, the wrinkle components increase more in the forehead in a period of 30 to 40 years old, while the wrinkle components tend to increase more in chin and outer eye corners from the age of 40. The database C provides the adjustment ratios δ0 for the respective face parts according to the reverse-aging steps N3 for adjustment of the coefficient α, in order to take these trends into consideration. The parameter setting unit 44 judges whether the age group of the reverse-aging period represented by the current age and the registration-time age corresponds to any one of the reverse-aging steps N3 in the database C. In the case where a result of judgment is affirmative, the parameter setting unit 44 reads the adjustment ratio or ratios δ0 for the corresponding reverse-aging step or steps N3, and multiplies the adjustment ratios together for finding an actual adjustment ratio δ. In the case where the result of judgment is negative, the parameter setting unit 44 uses 1 as the adjustment ratio for the respective face parts. For example, in the case where the person to be authenticated is 30 years old while his/her registration-time age is 20, none of the reverse-aging steps N3 in the database C correspond to the age group of the reverse-aging period. Therefore, the adjustment ratio δ for the respective face parts is 1. In the case where the person is 45 years old while his/her registration-time age is 31, the age group of the reverse-aging period corresponds to the reverse-aging steps N3 for over 40 and 40 to 30 years old. Therefore, 1 and 1.2 are read as the adjustment ratios δ0 corresponding to the steps N3 for forehead, and 1.2 (=1×1.2) is used as the actual adjustment ratio δ for forehead. For chin, 1.2 and 1 are read as the adjustment ratios δ0 for the reverse-aging steps N3, and 1.2 (=1.2×1) is used as the actual adjustment ratio δ for chin. Furthermore, 1.2 and 1 are read as the adjustment ratios δ0 for the reverse-aging steps N3 for outer eye corners, and 1.2 (=1.2×1) is used as the actual adjustment ratio δ for outer eye corners. For other face parts, 1 is used as the actual adjustment ratio δ therefor. In the case where the person is 39 years old while his/her registration-time age is 31, the age group of the reverse-aging period corresponds to the reverse-aging step N3 for 40 to 30 years old. Therefore, 1.2 is read as the corresponding adjustment ratio δ0 for forehead, and used as the actual adjustment ratio δ. For chin and outer eye corners, 1 is read as the adjustment ratio δ0 corresponding to the reverse-aging step N3, and used as the actual adjustment ratio δ. For other face parts, 1 is set as the actual adjustment ratio δ.

The second database 140 shown in FIG. 16 is for women, and the second database 140 in this embodiment respectively has the databases A, B, and C for women and for men. The parameter setting unit 44 reads the coefficient and the ratios from the corresponding databases according to the gender of the person to be authenticated.

The parameter setting unit 44 outputs the coefficient a read from the database A in the second database 140, the adjustment ratio γ obtained by multiplying together the adjustment ratios γ0 read from the database B, and the adjustment ratios δ for the respective face parts obtained by multiplication of the adjustment ratios δ 0 read from the database C, as the parameters W to the generation unit 46.

The generation unit 46 multiplies the respective wrinkle components Qm extracted by the wrinkle component extraction means 30 by an adjustment coefficient ρ, and obtains the reverse-aging image S′1 (Y1) by subtraction of a component (an adjustment component) obtained by the multiplication of the wrinkle components Qm by the adjustment coefficient ρ from the original image S0(Y0). The reverse-aging image generation means 40 carries out processing according to Equations (6) and (7) below:

$$\begin{matrix}{S}^{′} 1 = S0 - ρ {\sum }_{m = 1}^{n} {Q}_{m} & ( 6 ) \\ ρ = β ( S0 ) \times α \times γ \times δ & ( 7 )\end{matrix}$$

ρ: the adjustment coefficient

β: a coefficient depending on the pixel values

α: the coefficient read from the database A

γ: the adjustment ratio obtained by multiplying together the adjustment ratios γ0 read from the database B

δ: the adjustment ratios for the respective face parts obtained by multiplication of the adjustment ratios δ0 read from the database C

As has been described above, the coefficient α and the adjustment ratio γ are constant for the entire original image S0 while the adjustment ratios δ are set for the respective face parts in the face represented by the original image S0.

The coefficient β depending on the pixel values is expressed as β(S0), and is determined according to the luminance value Y0 of each of the pixels in the original image S0. More specifically, the larger the luminance value Y0 is, the larger the coefficient β becomes, when the luminance value Y1 is determined. The wrinkle components Qm extracted by the wrinkle component extraction means 30 may contain components of hair and the like, and it is preferable for the components of hair and the like to be prevented from being suppressed (that is, being subtracted) to the same degree as the components of wrinkles upon generation of the reverse-aging image. This embodiment pays attention to the fact that the skin part in which the wrinkles and the like are observed is generally light (that is, the skin part has a large luminance value) while a part representing the hair is dark (that is, the hair has a small luminance value). Therefore, the coefficient β that becomes larger (smaller) as a pixel has a larger (smaller) luminance value is used so that only a small amount is subtracted from the part corresponding to the hair while a large amount is subtracted from the skin part. In this manner, the components of true wrinkles, spots, and noise can be suppressed by the subtraction while the components representing hair can be suppressed less.

The reverse-aging image generation means 40 in the image generation unit 60 outputs the reverse-aging image S′1 generated in this manner to the compositing means 50, and the compositing means 50 combines the pixel value Y1 of the reverse-aging image S′1 output from the reverse-aging image generation means 40 with the color difference values Cr0 and Cb0 of the registered face image Dg obtained by the YCC conversion means 5. The compositing means 50 outputs the reverse-aging image D1(Y1, Cr0, Cb0) of the registered face image Dg to the comparison unit 70.

The comparison unit 70 in the authentication unit 100 carries out pattern matching on the reverse-aging image D1 output from the image generation unit 60 (the compositing means 50 in the image generation unit 60, more specifically) and the registered face image Dg output from the target identification means 3, and outputs a result of comparison to end the procedure.

FIG. 17 is a flow chart showing the procedure carried out in the authentication apparatus in this embodiment shown in FIG. 1. As shown in FIG. 17, in the authentication apparatus in this embodiment, the imaging unit 1 obtains the face image D0 of the person to be authenticated (S10), and the authentication unit 100 reads the registered face image Dg of the person, the registration-time age of the person corresponding to the registered face image Dg, the date of registration, and the gender from the first database 120 (S12). The authentication unit 100 extracts the wrinkle components Qm (m=1˜n) from the face image D0 obtained by the imaging unit 1, and reads the various kinds of parameters from the second database 140 according to the registration-time age of the registered face image Dg, the current age, and the gender for obtaining the coefficient α, the adjustment ratio γ, and the adjustment ratios δ for the respective face parts. The authentication unit 100 subtracts the adjustment component obtained by multiplication of a sum of the wrinkle components Qm by the coefficient α, the adjustment ratio γ, the adjustment ratios δ, and the coefficient β from the face image D0, for generating the reverse-aging image D1 (S14) . The authentication unit 100 compares the reverse-aging image D1 generated in this manner and the registered face image Dg, and outputs the result (S16) to end the procedure.

As has been described above, according to the authentication apparatus in this embodiment, the reverse-aging image is generated from the current-age image of the person at the time of authentication. Therefore, the reverse-aging image is not affected by an individual difference in appearance of age component, which realizes accurate authentication.

Furthermore, the length of reverse-aging span, the age groups in the reverse-aging period, and the face parts determine the adjustment of the age component. Therefore, the reverse-aging image can be generated more appropriately, which leads to improvement in authentication accuracy.

The authentication apparatus in this embodiment pays attention to the fact that the components such as wrinkles and spots are observed in various frequency bands ranging from high to low frequency bands, although the components tend to be observed more in high frequency bands. Therefore, the band-limited images Tm (m=1˜n, n≧2) representing the components of the various frequency bands of the original image S0(Y0) are generated and subjected to the non-linear conversion processing to extract conversion images as the wrinkle components. In this manner, the wrinkle components can be extracted thoroughly, and the reverse-aging image can be generated appropriately by subtraction of the wrinkle components.

Although the preferred embodiment of the present invention has been described above, the image generation method, the image generation apparatus, and the program of the present invention are not limited to the embodiment described above. Various modifications can be made thereto, within the scope of the present invention.

For example, the embodiment shown in FIG. 1 is used for authentication of a person by using the image generation method and the image generation apparatus of the present invention. At the time of authentication, the reverse-aging image is generated from the face image obtained at the time of authentication, and compared with the registered face image for authentication. However, the image generation method and the image generation apparatus of the present invention can be applied to an authentication system for carrying out authentication by generating an after-aging image. In addition, the image generation method and the image generation apparatus of the present invention can be applied to any system that needs an after-aging image and/or a reverse-aging image.

For example, authentication of a person may be carried out by generating an after-aging image from a registered face image according to a period from the registration-time age to the current age and by comparison with the registered face image, instead of authentication by generating the reverse-aging image from the face image at the time of authentication and by comparison of the past image with the registered face image as in the case of the authentication apparatus in the embodiment described above.

Furthermore, a predetermined age (such as a median age) between the registration-time age and the current age may be used as a reference age for generating an after-aging image from a registered face image representing aging from the registration-time age to the predetermined age and for generating a reverse-aging image from a face image obtained at the time of authentication representing reverse-aging from the current age to the predetermined age. The reverse-aging image and the after-aging image are then used for comparison. In this manner, accuracy of authentication can be improved especially in the case where the difference between the current age and the registration-time age is large.

For generating an after-aging image, the same procedure as the reverse-aging image generation can be used except that the adjustment component obtained by multiplication of the sum of the wrinkle components Qm extracted from the original image S0 by the adjustment coefficient ρ is added to the original image S0 according to Equation (8) below and the second database 140 used for obtaining the adjustment coefficient ρ is generated for an aging process. Therefore, description of the procedure is not repeated here.

$${S}^{′} 1 = S0 + ρ {\sum }_{m = 1}^{n} {Q}_{m} \qquad ( 8 )$$

Furthermore, the wrinkle components may be extracted according to any method of extraction of wrinkle components, such as the method described by Arakawa et al., instead of the method used by the wrinkle component extraction means 30 in the authentication apparatus in this embodiment.

The band-limited image generation means 20 in the authentication apparatus in this embodiment obtains the band-limited images according to Equation (4) with use of the original image S0 and the blurry images Sk (k=1˜n, n≧2), and the procedure carried out by the band-limited image generation means 20, the wrinkle component extraction means 30, and the reverse-aging image generation means 40 can be expressed collectively by Equation (9) below. However, the procedure carried out by the band-limited image generation means 20, the wrinkle component extraction means 30, and the reverse-aging image generation means 40 may be carried out according to Equations (10), (11) or (12) in which Sm (m=1˜n) refers to the blurry image and fm is the non-linear conversion function. In other words, the band-limited images may be obtained by subtraction between the images of neighboring frequency bands (assuming that the frequency band of the original image S0 is adjacent to the frequency band of the blurry image S1), as the procedure of Equation (9) carried out in the authentication apparatus of the present invention. Alternatively, the band-limited images may be obtained through subtraction between the original image and the respective blurry images as shown in Equation (10), or by subtraction between the blurry images of neighboring frequency bands without involving the original image, as shown by Equation (11). Furthermore, the band-limited images may be obtained by subtraction between the blurry image S1 and the other blurry images Sm (m=2˜n, n≧3) without involving the original image, as shown by Equation (12) below:

$$\begin{matrix}{S}^{′} 1 = S0 - ρ {\sum }_{m = 1}^{n} {f}_{m} ( S ( m - 1 ) - Sm ) & ( 9 ) \\ {S}^{′} 1 = S0 - ρ {\sum }_{m = 1}^{n} \frac{1}{n} \cdot {f}_{m} ( S0 - Sm ) & ( 10 ) \\ {S}^{′} 1 = S0 - ρ {\sum }_{M = 1}^{n} {f}_{m} ( Sm - S ( m + 1 ) ) & ( 11 ) \\ {S}^{′} 1 = S1 - ρ {\sum }_{M = 1}^{n} \frac{1}{n - 1} \cdot {f}_{m} ( S1 - Sm ) & ( 12 )\end{matrix}$$

Furthermore, the band-limited images may be generated not only by the methods represented by Equations (4) and (9) to (12) using the original image and the blurry images generated from the original image but also according to any method, as long as the images representing the components of the frequency bands in the original image can be expressed.

Since this embodiment is an application of the image generation method and the image generation apparatus of the present invention to authentication, the reverse-aging image is generated from the face image D0 representing an entire face. However, the image generation method and the image generation apparatus of the present invention can be applied to the case of generating a reverse-aging image and an after-aging image of face parts such as a part around eyes, cheeks, and forehead (that is, face-part images of different ages), in addition to an entire face. If the face-part images generated in this manner are used in the system described in Japanese Unexamined Patent Publication No. 2002-304619, simulation according to age can be realized.

Furthermore, the present invention can be applied to video games in such a manner that a face image of a person at a predetermined age is generated and used for generation of a reverse-aging image or an after-aging image according to a change in time with development of a story. In this case, the face image at the predetermined age may be generated as a computer graphic image or may be provided by a player himself/herself as his/her photograph.

In addition, the image generation method and the image generation apparatus of the present invention may be applied to generation of a reverse-aging image or an after-aging image of any skin part other than face or a face part such as neck and hands in which the age component such as the wrinkle components increases or decreases with aging.

In the embodiment described above, the adjustment coefficient ρ is changed by the adjustment coefficients α and β and the adjustment ratios γ and δ, according to Equation (7). However, the adjustment coefficient ρ may be changed by adjustment ratios ζ and η described below.

For example, the adjustment coefficient ρ may be changed by the adjustment ratio ζ representing a degree of wrinkles and spots in the current-age image, according to Equation (13) below:
ρ=β(S0)×α×γ×δ×ζ (13)

More specifically, an amount of wrinkles and spots varies between people of the same age. For example, the amount of the components of wrinkles and spots tends to decrease more in reverse aging of a person currently having more amount of the components of wrinkles and spots, while the amount tends to increase less in aging. The adjustment ratio ζ is therefore changed according to this tendency. On the contrary, the amount of the components of wrinkles and spots tends to decrease less in reverse aging of a person currently having less amount of the components of wrinkles and spots, while the amount tends to increase more or maintain a current level in aging. Consequently, the adjustment ratio ζ is changed according to this tendency.

As has been described above, the adjustment ratio ζ for the components of wrinkles and spots in generation of the after-aging or reverse-aging image is changed according to the amount of the components of wrinkles and spots in the image that has been obtained, and the adjustment ratio ζ is used to be reflected in the adjustment coefficient ρ. In this manner, the after-aging image or the reverse-aging image can be generated more accurately.

The adjustment coefficient ρ may be changed according to the adjustment ratio η representing use or nonuse of makeup, as shown in Equation (14) below:
ρ=β(S0)×α×γ×δ×η (14)

More specifically, appearance of wrinkles and spots changes considerably according to use or nonuse of makeup. For example, in the case of use of makeup at the time of acquisition of the current-age image, the components of wrinkles and spots tend to be extracted less. Therefore, the adjustment coefficient ρ is strengthened by an increase in the adjustment ratio η. In the case of generation of the after-aging image or the reverse-aging image with makeup, the adjustment coefficient ρ is weakened by a decrease in the adjustment ratio η for aging or reverse aging so that the components of wrinkles and spots appear less conspicuously than they actually would. By changing the adjustment ratio η for the components of wrinkles and spots according to use or nonuse of makeup in the image that has been obtained or in the after-aging image or the reverse-aging image to be generated, the after-aging image or the reverse-aging image can be generated more accurately.

In Equations (13) and (14), the adjustment ratios ζ and η are used respectively. However, the adjustment ratios ζ and η may be used together for calculating the adjustment coefficient ρ, such as ρ=β(S0)×α×γ×δ×ζ×η.

In the embodiment described above, the second database 140 comprises the databases A, B, and C. However, the second database 140 may have a plurality of sets of databases A, B, and C according to colors of skin. More specifically, the components of wrinkles and spots tend to appear differently, depending on the colors of skin. For example, a change in the components of wrinkles and spots with aging is not conspicuous in the case of black skin, while the change is conspicuous in the case of white skin. Therefore, by preparing the sets of databases A, B, and C according to the colors of skin and by using the adjustment coefficients p and a and the adjustment ratios γ, δ, ζ, and η based on the tendency in increase or decrease in the components of wrinkles and spots according to the colors of skin, the after-aging image or the reverse-aging image can be generated more accurately.

What is claimed is:

1. An image generation method for generating an after-aging image representing an image of a skin part of a person after aging and/or a reverse-aging image representing an image of the skin part of the person in reverse aging by using an image of the skin part of the person at a predetermined age as a current-age image, the image generation method comprising the steps of:
extracting a component as an age component from the current-age image, the component enabling representation of a state of skin and increasing with aging;
obtaining an adjustment component by adjusting the age component with a predetermined adjustment strength; and
adding the adjustment component to the current-age image in the case of generating the after-aging image and subtracting the adjustment component from the current-age image in the case of generating the reverse-aging image.

2. The image generation method according to claim 1, wherein the age component is a wrinkle component and/or a spot component.

3. The image generation method according to claim 2, wherein the step of extracting the component comprises the steps of:
generating a plurality of band-limited images representing components in a plurality of frequency bands of the current-age image, based on the current-age image;
obtaining pixel values of a plurality of conversion images by carrying out non-linear conversion processing on each pixel value of each of the band-limited images, the non-linear conversion processing causing an absolute value of an output value to become not larger than an absolute value of a corresponding input value, the non-linear conversion processing causing an absolute value of an output value to become larger as an absolute value of a corresponding input value becomes larger if the absolute value of the corresponding input value is not larger than a predetermined threshold value, the non-linear conversion processing causing an absolute value of an output value to become not larger than an absolute value of an output value corresponding to the predetermined threshold value if the absolute value of the corresponding input value is larger than the predetermined threshold value; and
obtaining pixel values of an age component image representing the age component by adding up the pixel values of corresponding pixels in the respective conversion images.

4. The image generation method according to claim 3, wherein the step of obtaining the adjustment component is the step of obtaining pixel values of an image representing the adjustment component by multiplying the pixel values of the age component image by an adjustment coefficient representing the adjustment strength.

5. The image generation method according to claim 4, wherein the adjustment coefficient is determined according to each pixel value of the current-age image.

6. The image generation method according to claim 1, wherein the adjustment strength causes the adjustment component to become larger as a degree of aging or reverse aging becomes larger.

7. The image generation method according to claim 6, wherein the adjustment strength is determined according to an age group in a period of aging or reverse aging.

8. The image generation method according to claim 1, wherein the adjustment strength is determined according to a body part to which the skin part of the person belongs.

9. The image generation method according to claim 1, wherein the adjustment strength is determined according to a degree of the age component extracted from the current-age image.

10. The image generation method according to claim 1, wherein the adjustment strength is determined according to use or nonuse of makeup in the current-age image or in the after-aging image or the reverse-aging image.

11. The image generation method according to claim 1, wherein the adjustment strength is determined according to a color of the skin of the person.

12. An image generation apparatus for generating an after-aging image representing an image of a skin part of a person after aging and/or a reverse-aging image representing an image of the skin part of the person in reverse aging by using an image of the skin part of the person at a predetermined age as a current-age image, the image generation apparatus comprising:
age component extraction means for extracting a component as an age component from the current-age image, the component enabling representation of a state of skin and increasing with aging;
adjustment component acquisition means for obtaining an adjustment component by adjusting the age component with a predetermined adjustment strength; and
image generation means for generating the after-aging image by adding the adjustment component to the current-age image and for generating the reverse-aging image by subtracting the adjustment component from the current-age image.

13. The image generation apparatus according to claim 12, wherein the age component is a wrinkle component and/or a spot component.

14. The image generation apparatus according to claim 13, wherein the age component extraction means
generates a plurality of band-limited images representing components in a plurality of frequency bands of the current-age image, based on the current-age image;
obtains pixel values of a plurality of conversion images by carrying out non-linear conversion processing on each pixel value of each of the band-limited images, the non-linear conversion processing causing an absolute value of an output value to become not larger than an absolute value of a corresponding input value, the non-linear conversion processing causing an absolute value of an output value to become larger as an absolute value of a corresponding input value becomes larger if the absolute value of the corresponding input value is not larger than a predetermined threshold value, the non-linear conversion processing causing an absolute value of an output value to become not larger than an absolute value of an output value corresponding to the predetermined threshold value if the absolute value of the corresponding input value is larger than the predetermined threshold value; and
obtains pixel values of an age component image representing the age component by adding up the pixel values of corresponding pixels in the conversion images.

15. The image generation apparatus according to claim 14, wherein the adjustment component acquisition means obtains pixel values of an image representing the adjustment component by multiplying the pixel values of the age component image by an adjustment coefficient representing the adjustment strength.

16. The image generation apparatus according to claim 15 wherein the adjustment coefficient is determined for each pixel value of the current-age image.

17. The image generation apparatus according to claim 12, wherein the adjustment strength becomes larger as a degree of aging or reverse aging becomes larger.

18. The image generation apparatus according to claim 17, wherein the adjustment strength is determined according to an age group in a period of aging or reverse aging.

19. The image generation apparatus according to claim 12, wherein the adjustment strength is determined according to a body part to which the skin part of the person belongs.

20. The image generation apparatus according to claim 12, wherein the adjustment strength is determined according to a degree of the age component extracted from the current-age image.

21. The image generation apparatus according to claim 12, wherein the adjustment strength is determined according to use or nonuse of makeup in the current-age image or in the after-aging image or the reverse-aging image.

22. The image generation apparatus according to claim 12, wherein the adjustment strength is determined according to a color of the skin of the person.

23. An information recording medium storing a program for causing a computer to execute image generation processing for generating an after-aging image representing an image of a skin part of a person after aging and/or a reverse-aging image representing an image of the skin part of the person in reverse aging by using an image of the skin part of the person at a predetermined age as a current-age image, the program comprising:
age component extraction processing for extracting a component as an age component from the current-age image, the component enabling representation of a state of skin and increasing with aging;
adjustment component extraction processing for obtaining an adjustment component by adjusting the age component with a predetermined adjustment strength; and
image generation processing for obtaining the after-aging image by adding the adjustment component to the current-age image and for generating the reverse-aging image by subtracting the adjustment component from the current-age image.

24. An information recording medium storing the program according to claim 23, wherein the age component is a wrinkle component and/or a spot component.

25. An information recording medium storing the program according to claim 24, wherein the age component extraction processing comprises the steps of:
generating a plurality of band-limited images representing components in a plurality of frequency bands of the current-age image, based on the current-age image;
obtaining pixel values of a plurality of conversion images by carrying out non-linear conversion processing on each pixel value of each of the band-limited images, the non-linear conversion processing causing an absolute value of an output value to become not larger than an absolute value of a corresponding input value, the non-linear conversion processing causing an absolute value of an output value to become larger as an absolute value of a corresponding input value becomes larger if the absolute value of the corresponding input value is not larger than a predetermined threshold value, the non-linear conversion processing causing an absolute value of an output value to become not larger than an absolute value of an output value corresponding to the predetermined threshold value if the absolute value of the corresponding input value is larger than the predetermined threshold value; and
obtaining pixel values of an age component image representing the age component by adding up the pixel values of corresponding pixels in the respective conversion images.

26. An information recording medium storing the program according to claim 25, wherein the adjustment component acquisition processing is processing for obtaining pixel values of an image representing the adjustment component by multiplying the pixel values of the age component image by an adjustment coefficient representing the adjustment strength.

27. An information recording medium storing the program according to claim 26, wherein the adjustment coefficient is determined according to each pixel value of the current-age image.

28. An information recording medium storing the program according to claim 23, wherein the adjustment strength causes the adjustment component to become larger as a degree of aging or reverse aging becomes larger.

29. An information recording medium storing the program according to claim 28, wherein the adjustment strength is determined according to an age group in a period of aging or reverse aging.

30. An information recording medium storing the program according to claim 23, wherein the adjustment strength is determined according to a body part to which the skin part of the person belongs.

31. An information recording medium storing the program according to claim 23, wherein the adjustment strength is determined according to a degree of the age component extracted from the current-age image.

32. An information recording medium storing the program according to claim 23, wherein the adjustment strength is determined according to use or nonuse of makeup in the current-age image or in the after-aging image or the reverse-aging image.

33. An information recording medium storing the program according to claim 23, wherein the adjustment strength is determined according to a color of the skin of the person.
